(19) United States
(12) Patent Application Publication
(10) Pub. No.: US 2014/0082364 A1
(43) Pub. Date: Mar. 20, 2014

(54) Collaborative Uses of a Cloud Computing Confidential Domain of Execution

(71) Applicants: Tommaso Cucinotta, Blanchardstown (IE); Davide Cherubini, Castleknock (IE); Eric B. Jul, Roskilde (DK)

(72) Inventors: Tommaso Cucinotta, Blanchardstown (IE); Davide Cherubini, Castleknock (IE); Eric B. Jul, Roskilde (DK)

(21) Appl. No.: 13/622,007

(22) Filed: Sep. 18, 2012

(51) Int. Cl. H04L 9/32

(52) U.S. Cl. 713/171

(57) ABSTRACT

An exemplary confidential computing system includes a computing device. A cryptographic processing unit is associated with the computing device. The cryptographic processing unit is configured to use a first user key for encrypting a communication to the first user that includes information from the computing device. The cryptographic processing unit is also configured to use the first user key for decrypting any first user information received from the first user device before allowing the received first user information to be available to the computing device. The processing unit is also configured to use at least one other key received from the first user device for processing any other information received from at least one other source.

### TECHNICAL FIELD

The subject matter of this document relates generally to cloud computing. More particularly, the subject matter of this document relates to secure cloud computing.

### RELATED TECHNOLOGY

Cloud computing has grown in popularity and capability. Cloud computing allows users to access computing resources that are managed or provided by others. One significant advantage associated with cloud computing is that a user need not make the investment necessary to realize computing capabilities that are not possible with the user's own equipment. Instead of having to purchase and maintain all computing resources needed for various tasks, a user may access the resources of others to complete those tasks.

One drawback associated with not using one's own computing resources is that the resources storing and communicating information, particularly sensitive or confidential information, may be under control of a third party. Lack of control over resources storing and communicating information may compromise the security of such information or computing operations unless the cloud service provider has one or more mechanisms or techniques in place to ensure security or confidentiality. The task of maintaining security in a cloud computing environment becomes even more complex when multiple users desire access to the same physical resources for carrying out their operations (i.e., multi-tenancy) or when multiple users or multiple sources of information are interested in or involved with the same computing operations or information.

### SUMMARY

An exemplary confidential computing system includes at least one computing device. A cryptographic processing unit associated with the computing device is configured to encrypt a communication to the first user, which includes information from the computing device, based on a first user key. The cryptographic processing unit is also configured to determine decrypted first user information based on the first user key and information received from the first user. The cryptographic processing unit provides the decrypted information to the computing device. The processing unit is also configured to use at least one other key received from the first user device for processing other information received from at least one other source.

An exemplary method of computing using a cryptographic processing unit associated with a computing device includes controlling access to information available to or processed by the computing device by the cryptographic processing unit by encrypting a communication to a first user, which includes information from the computing device, based on a first user key. Determining decrypted first user information is based on the first user key and encrypted information received from the first user. The decrypted information is provided to the computing device. The method includes using at least one other key received from the first user for processing other information received from at least one other source.

Various features of disclosed example embodiments will become apparent to those skilled in the art from the following detailed description. The drawings that accompany the detailed description can be briefly described as follows.

### BRIEF DESCRIPTION OF THE DRAWINGS

FIG. 1 schematically illustrates a cloud computing system including a confidential domain of execution designed according to an embodiment of this invention.

FIG. 2 schematically illustrates an arrangement designed according to an embodiment of this invention for providing collaborative use of secure information among multiple users or multiple confidential domains of execution.

FIG. 3 schematically illustrates an example communication useful with the embodiment of FIG. 2.

FIG. 4 schematically illustrates another example communication useful with the embodiment of FIG. 2.

FIG. 5 schematically illustrates another communication technique useful with an embodiment of this invention.

FIG. 6 schematically illustrates a communication technique associated with the technique schematically shown in FIG. 5.

### DETAILED DESCRIPTION

The example system, techniques and devices presented in the following description are useful for facilitating cloud computing in a confidential domain of execution that ensures the confidentiality or security of computing operations and information in the cloud. The example techniques and devices ensure security over computing operations or information within confidential domains of execution while facilitating collaborative uses of the computing operations or information within one or more of those domains. For example, a disclosed technique allows multiple users to share access to secure computing functions or information within one or more confidential domains of execution. Another example technique facilitates another source besides a secure user providing information to the confidential domain of execution instead of requiring the user, itself, to provide that information.

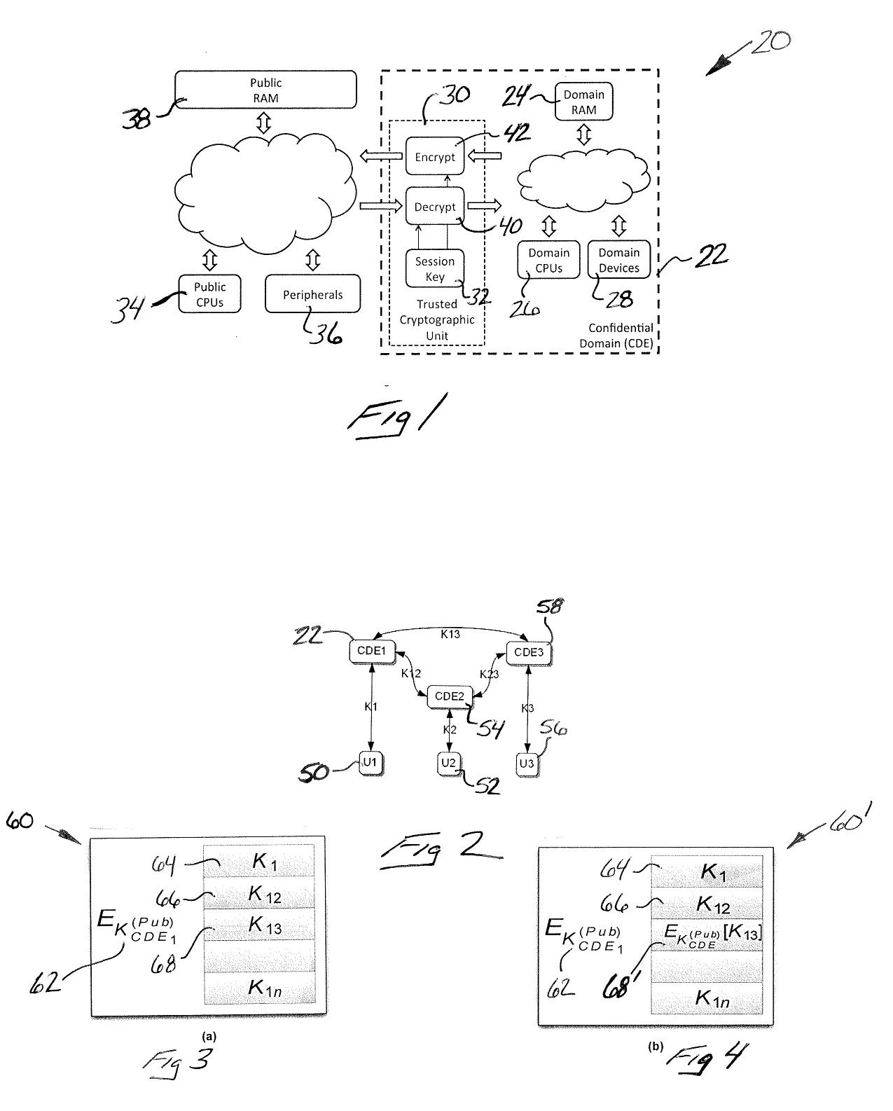

FIG. 1 schematically shows a cloud computing system 20. A confidential domain of execution 22 is configured to maintain security or confidentiality of information on behalf of one or more users. The confidential domain of execution (CDE) 22 includes a memory or data storage 24 and computing devices or machines 26, such as central processing units that are configured to perform one or more computing operations on information within the CDE 22 including information in the data storage 24. The illustrated example may include other domain devices 28 configured to perform one or more operations on the information within the CDE 22, including operations that may be needed to help move data within the CDE 22 or operations to carry out specialized computations. Hardware accelerators and DMA controllers are example domain devices 28 that may be included in some embodiments. The domain devices 28 may be considered a computing device within the context of this description.

The schematic division of the devices or components in FIG. 1 is for discussion purposes. One or more of the devices may be integrated into another. For example, some example implementations will include at least part of the data storage 24 as part of a computing device 26. It is also possible that the a computing device 26 will be realized through various devices that are physically separate from each other.

The CDE 22 includes a trusted cryptographic processing unit 30 that utilizes a session key schematically shown at 32 for controlling information transfers between the CDE 22 and publicly available portions of the cloud computing system 20. FIG. 1 schematically shows user devices such as central processing units 34 and peripheral devices 36 that various users may utilize for performing one or more computing functions. A publicly available data storage or memory 38 may be used for cloud computing when security or confidentiality is not necessarily of a concern.

The cryptographic processing unit 30 provides confidentiality or security for information and computing functions within the CDE 22. In this example, all communications from outside of the CDE 22 into the CDE 22 are processed by the cryptographic processing unit 30. As schematically shown at 40, the cryptographic processing unit 30 decrypts all communications from outside of the CDE 22 into the CDE 22. This includes decrypting all information received from a user outside of the CDE 22 before that information is made available to the computing devices 26 and 28 or allowed to be included in the data storage 24. The cryptographic processing unit 30 also encrypts information provided to a user outside of the CDE as schematically shown at 42. The illustrated example provides secure, encrypted communications outside of the CDE 22 while allowing unencrypted information and computing operations within the CDE 22.

In one example, a user desiring to take advantage of the computing capabilities available from the CDE 22 provides a communication of a predetermined format to at least initialize a cloud computing session involving the CDE 22. In one example, a user provides a symmetric user key K-user that is encrypted with the public key of the CDE 22. In one example, the cryptographic processing unit 30 is preconfigured by a manufacturer with a unique, built-in asymmetric key pair. The private key of the cryptographic processing unit is injected into the cryptographic processing unit 30 during manufacture and stored in tamper-resistant hardware, such as a trust platform module in some examples. The corresponding public key of the cryptographic processing unit 30 is made available for users through public-key certificates. In one such example, a cloud computing session with the CDE 22 is initialized upon receipt of a symmetric user key K-user encrypted with the public key of the cryptographic processing unit 30. Advantageously, initialized cloud computing sessions provide that an intended CDE 22 may securely receive and utilize the user key. In one example, the symmetric user key K-user is not made available to the devices 26 or 28 or the data storage 24 within the CDE 22. The computing elements 34 and the possible other peripherals 36 outside of the CDE 22 are not be capable of accessing information internal to the CDE 22, including information stored onto internal CDE storage 24, status of the processing units 26 internal to the CDE 22, status of any other peripheral 28 internal to the CDE 22, or any information available on the interconnection bus or logic used to let all the components internal to the CDE 22 communicate with each other.

Whenever the CDE 22 attempts to provide data to a user outside of the CDE 22, that data is forcibly encrypted by the encryption module 42 of the cryptographic processing unit 30 using the user's symmetric key K-user. Such encrypted data may be sent to the user through the untrusted or publicly available domain, for example. The encrypted data can only be decrypted by someone with access to the symmetric user key that was used for encrypting the data. A legitimate user that receives such data can decrypt the data based upon the appropriate, symmetric user key.

The cryptographic processing unit 30 provides security and confidentiality for information and computing operations within the CDE 22 and allows for users to take advantage of the capabilities of the CDE 22 to realize the benefits of cloud computing without having to expose confidential or secure information.

The system illustrated in FIG. 1 allows for collaborative use of the computing operations or information within the CDE 22. FIG. 2 schematically illustrates a scenario that includes collaborative use and multiple CDEs. A first user 50 accesses and uses the CDE 22 configured with a first user key K1. A second user 52 accesses and utilizes a second CDE 54 configured with a second user key K2. A third user 56 accesses and utilizes a third CDE 58 configured with a third user key K3. In the example of FIG. 2, it is desirable for one or more of the users to be able to share computing operations or information from its CDE with one or more of the other CDEs, one or more of the other users, or both. The example of FIG. 2 allows for information from one of the CDEs to be shared with another one of the CDEs to allow for the users to effectively share that information while still maintaining the security and confidentiality control over that information that is provided by each of the CDEs.

In the example of FIG. 2, each of the users 50, 52 and 56 desires to perform confidential computations within its own CDE while still having control on which part of the confidential information or confidential computing algorithms to share with other users. The software loaded within each of the example CDEs 22, 54 and 58 will be able to securely communicate with the other CDEs using the additionally configured keys. For example, the CDE 22 of the first user 50 can use a key K12 additionally configured within its cryptographic processing unit 30 to securely communicate with the CDE 54 of the second user 52 or directly with the second user 52. The CDE 22 of the first user 50 can also use another key k13 additionally configured within the cryptographic processing unit 30 to securely communicate with the CDE 58 of the third user 56 or directly with the third user 56.

The users in this example provide a communication to the respective CDE of a predetermined format that allows the CDE to establish secure communications with another CDE on behalf of that user. FIG. 3 schematically illustrates an example initialization message, which satisfies the predetermined communication format for one example embodiment. In this example, the initialization message 60 is encrypted with the public key of the CDE shown at 62.

Considering the first user 50 and the CDE 22 as an example, the public key at 62 corresponds to the public key of the CDE 22. The user 50 also provides a first user key shown at 64 (e.g., the key K1 of FIG. 2) that is used for all secure communications between the CDE 22 and the first user 50. For example, the first user key 64 is used for encrypting all information sent from the user 50 to the CDE 22. The cryptographic processing unit of the CDE 22 decrypts all information received from the user 50 using the first user key 64. The CDE 22 also uses the first user key 64 for encrypting all information sent to the first user 50.

Another key 66 (e.g., the key K12 of FIG. 2) is provided to the CDE 22 within the initialization message 60. In this example, the key 66 is a key to be used by the CDE 22 for communicating with the second CDE 54 or the second user 52 so that the second user 52 and the first user 50 may have common access to computing operations or information from either of the CDEs 22 or 54. In this example, the key at 66 is dedicated exclusively to being used for encrypting and decrypting information shared between the CDEs 22 and 54 on behalf of the first user 50 and the second user 52. In other words, any computing operations or information protected with the other key 66 is only made available to the first user 50 and the second user 52.

Another key schematically shown at 68 is provided by the first user 50 to the CDE 22 to facilitate the CDE 22 communicating with the third CDE 58. Such information sharing allows for the first user 50 and the third user 56 to have common access to the same computing operations or information. In this example, the key schematically shown at 68 is exclusively dedicated to encrypting and decrypting information exchanged between the CDEs 22 and 58 on behalf of the first user 50 and the third user 56.

An initialization message from the second user 52 will include at least the key shown at 66 so that the same key is used by the second CDE 54 and the CDE 22 for purposes of sharing computing operations or information that should be made available to the first user 50 and the second user 52. The third user 56 will provide an initialization message that includes at least the key 68 so that the CDEs 22 and 58 each have the same key for encrypting and decrypting information exchanged between them on behalf of the first user 50 and the third user 56.

In one example, the initialization message must contain all keys to be used by the CDE on behalf of a particular user and a cryptographic algorithm is used to work against a potential attacker attempting to tamper with the initialization message. It should be appreciated that requiring a predetermined format such as an initialization message that includes all keys helps to prevent an attacker from replacing a key or inserting an additional key. For example, an attacker may try to replace one or more keys of an initialization message sent by a user or to replace parts or blocks of the message with parts or blocks from another initialization message previously sent by other users or the attacker, itself.

In the example of FIG. 3, all of the keys schematically shown at 64, 66, and 68 are encrypted using the public key schematically shown at 62 of the CDE to which the message was directed.

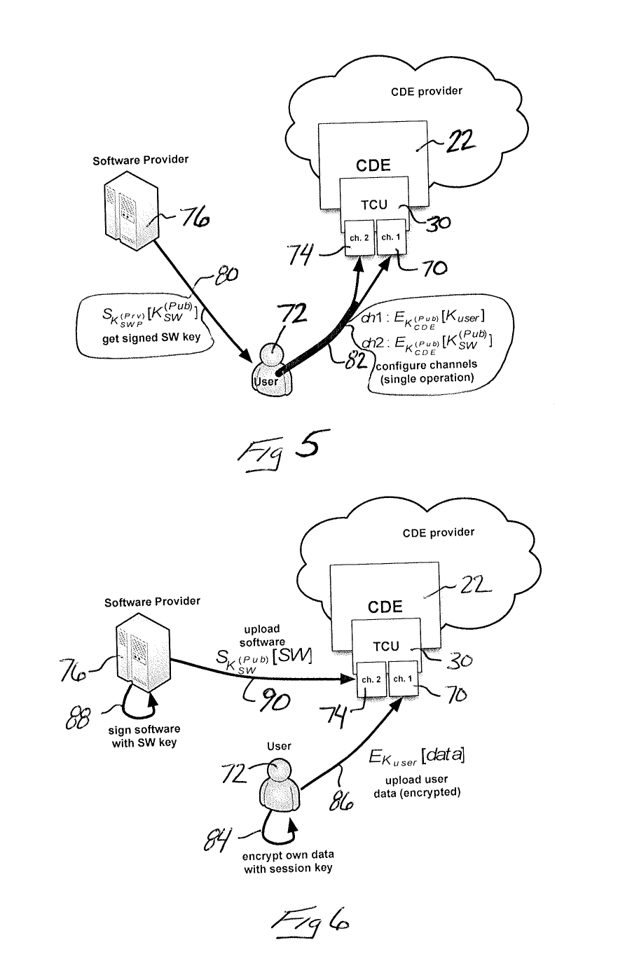

In the example of FIG. 3, the keys provided by the user sending the initialization message 60 are potentially decipherable by the first user. The example of FIG. 4 provides an additional layer of security. In this example, an initialization message 60′ includes a plurality of keys at 64, 66, and 68′ that are each encrypted using the public key 62 of the CDE to which the message 60′ is directed. In this example, the key 68′ is encrypted before it is provided to the user that sends the initialization message 60′. A public key used for encrypting the key 68′ is known or provided to the CDE that will be receiving the message 60′ so that all of the keys may be decipherable for purposes of carrying out desired communications among the CDEs on behalf of the various users.

The example of FIG. 4 allows for a primary user to collect encrypted keys from other parties without those other parties having to disclose the actual key to the primary user. Such keys are encrypted using the public key of the CDE, for example, so that the primary user cannot see the actual key but only pass it on to the CDE. This has an additional advantage of preventing a primary user from forwarding such keys to other, potentially untrusted parties.

The cryptographic processing unit of each CDE in the example of FIG. 2 is configured to securely store multiple encryption keys along with the necessary parameters, such as the mode of operation for each key, and associate them with a key identifier. Communications in this example involve each message flowing in and out of a CDE being explicitly tagged with the identifier of the encryption key to be used for the cryptographic operations. This effectively establishes a separate flow for each key. For example, some communication flows of a CDE are realized as DMA operations. When programming the DMA operation within the registers of the cryptographic processing unit, an additional key identifier register is programmed to specify the identifier of one or more keys among the ones that have been used to initialize the session with the CDE. The use of a key identifier not corresponding to any of the cryptographic keys provided at initialization (or another predetermined communication) will result in the immediate failure of the operation in at least some example embodiments. Such an event can be inspected and used for reporting errors or to flag a possible intrusion attack.

The examples of FIGS. 2-4 allow for multiple users to have common access to confidential or secure computing operations or information within a CDE. In the case of FIGS. 3 and 4, each user provides specific keys 66 and 68 that are useful for the CDEs to share computing functions or exchange information on behalf of two particular users. In another example, every CDE uses a single key, which is different than any of the user keys, for exchanging information among the CDEs on behalf of any of the users. In other words, the initialization message (or other communication having a predefined format) includes the user key and a single key for use by the CDEs for purposes of exchanging a computing operation or information in a secure manner so that the computing operation or information is available to more than one of the users through its respective CDE. Rather than having a set of dedicated keys for protecting information that is available to different sets of two of the users, any of the CDEs may exchange information with any other CDE on behalf of any of the users using a single, special key.

Another example includes a combination of such keys. At least one key is dedicated to information that is to be available to two specified users. At least one other key is useful for exchanging information among the CDEs if such information is available to any of the authorized users.

Any of the users 50, 52 or 56 may specify which computing operations or information should be kept confidential within its CDE and those that may be used in a collaborative manner.

FIG. 5 schematically illustrates another scenario in which the CDE 22 provides security and confidentiality protection over computing operations or information. In this example, the CDE 22 communicates over a first channel 70 with a user 72. The CDE 22 communicates over a second channel 74 with another source of information 76, such as a software or database provider. The cryptographic processing unit 30 utilizes the channels 70 and 74 depending on the particular communication.

In this example, the user 72 receives a signed key as schematically shown at 80. The signed key may come directly from the source 76 or it may be communicated to the user 72 by a certification authority. In one example, the signed key comprises an authentication key that is useful for indicating when software or data from the source 76 is authentic or trustworthy. The user 72 provides a communication of a predetermined format as schematically shown at 82 to the cryptographic processing unit 30. In this example, the communication 82 comprises an initialization message.

The communication schematically shown at 82 includes the public key of the user 72 for establishing communications over the first channel 70 through the cryptographic processing unit 30. The user key will be used for decrypting information from the user 72 (when that information has been encrypted by the user 72 and communicated to the cryptographic processing unit 30 over the channel 70). The cryptographic processing unit 30 also uses the user key for encrypting information that is communicated over the first channel 70 to the user 72.

The communication schematically shown at 82 also includes the other key from the source 76. The cryptographic processing unit 30 utilizes the other key for establishing the second channel 74 and will use that other key for authenticating communications received over that channel to ensure that such communications are trustworthy.

FIG. 6 schematically illustrates a technique to allow the user 72 to perform one or more computing functions using the CDE 22. As schematically shown at 84, the user 72 encrypts information using its user key. The encrypted information is communicated as schematically shown at 86 to the CDE 22 over the first channel 70. The cryptographic processing unit 30 decrypts such information before allowing it into the CDE 22 where it will be available to the computing devices 26, 28 (FIG. 1). In this situation, the user 72 desires to have software from a source 76 available for the computing functions to be performed in the CDE 22. Rather than requiring the user 72, itself, to transfer such software to the CDE 22, the CDE is configured to accept communications directly from the source 76. As schematically shown at 88 the source 76 signs the software using the same key previously provided to the user 72 and from the user 72 to the CDE 22. The source 76 communicates the signed software as schematically shown at 90 to the CDE 22 over the second channel 74. The cryptographic processing unit 30 processes such a communication by verifying that the authentication key is valid and that the information from the source 76 is trustworthy. If so, the software is made available to (e.g., incorporated into or otherwise called upon by) one or more of the computing devices 26, 28 within the CDE 22 so that it is useful for the user 72 to perform desired computing operations within the CDE 22. The cryptographic processing unit 30 encrypts any information communicated to the user 72 over the channel 70, which is based on information provided to the CDE 22 by the source 76, with the user key.

The techniques shown in FIGS. 5 and 6 allow for providing authenticated, plain-text input data to a CDE and enable a scalable distribution of software and data by a provider to large communities of users. At the same time, it maintains security and confidentiality over information and computations within the CDE. The illustrated example provides a more efficient way to load software and data into a CDE on behalf of a user by allowing software or data from another source to be admitted when it is authenticated and by utilizing the encryption and decryption described above for all communications directly with the user. For example, it is possible for a user to have a third-party software program, operating system, library, middleware or application to be available within the CDE to perform a desired computing function while, at the same time, achieving security and confidentiality protection for the user's computing operations or information.

One feature of the example of FIGS. 5 and 6 is that significant or large amounts of software or data do not need to be separately encrypted by the user 72 nor decrypted by the cryptographic processing unit 30. In some examples, the source 76 may be closely associated with the CDE 22 to provide enhanced efficiencies when communicating the software or data to the CDE 22.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A confidential computing system, comprising:
a computing device configured to perform at least one computing function;
a cryptographic processing unit associated with the computing device, the cryptographic processing unit being configured to
encrypt a communication to a first user based on a first user key, the communication including information from the computing device;
determine decrypted first user information based on the first user key and encrypted information from the first user;
provide the computing device access to the decrypted first user information; and
use at least one other key received from the first user for processing other information received from at least one other source.

2. The system of claim 1, wherein the cryptographic processing unit is configured to
determine decrypted other information based on the at least one other key and the other information received from the at least one other source;
provide the computing device access to the decrypted other information; and
encrypt a communication to the at least one other source based on the at least one other key, the communication to the at least one other source including information from the computing device.

3. The system of claim 2, wherein
the other source comprises a second cryptographic processing unit;
the second cryptographic processing unit communicates with a second user;
the cryptographic processing unit uses the at least one other key for at least one of encrypting and decrypting information communicated between the cryptographic processing unit and the second cryptographic processing unit.

4. The system of claim 3, wherein the cryptographic processing unit is configured to
use the at least one other key for encrypting a communication to the second user;
determine decrypted second user information based on the at least one other key; and
provide the decrypted information to the computing device.

5. The system of claim 1, wherein the cryptographic processing unit is configured to
use the first user key for communications with the first user device over a first communication channel; and
use the at least one other key for communications with the at least one other source over a second communication channel.

6. The system of claim 1, wherein
the at least one other key comprises an authentication indicator that indicates when information from the at least one other source is trustworthy;
the cryptographic processing unit is configured to use the at least one other key for authenticating information received from the at least one other source; and
provide the authenticated information to the computing device.

7. The system of claim 6, wherein
the at least one other source is at least one of a data provider or a software provider; and
the computing device uses the at least one of data or software from the other source during at least one computing operation for the first user.

8. The system of claim 6, wherein the cryptographic processing unit is configured to use the first user key for encrypting a communication to the first user that includes information from the computing device that is based on information received from the at least one other source.

9. The system of claim 1, wherein the cryptographic processing unit is configured to
authorize use of the computing device only responsive to receiving both of the first user key and the at least one other key in a predetermined communication format; and
prevent use of the computing device if the first user key and the at least one other key are not received in the predetermined communication format.

10. The system of claim 9, wherein
the predetermined communication format comprises a single communication from the first user to the cryptographic processing unit, the single communication indicating a desire of the first user to begin a cloud computing session including the computing device.

11. A method of computing using a cryptographic processing unit associated with a computing device, comprising the steps of:
controlling access to information available to or processed by the computing device by the cryptographic processing unit by
encrypting a communication to a first user based on a first user key, the communication including information from the computing device;
determining decrypted first user information based on the first user key and encrypted information from the first user;
providing the computing device access to the decrypted first user information; and
using at least one other key received from the first user for processing other information received from at least one other source.

12. The method of claim 11, comprising
determining decrypted other information based on the at least one other key and the other information received from the at least one other source;
providing the decrypted other information to the computing device; and
encrypting a communication to the other source based on the at least one other key, the communication to the other source including information from the computing device.

13. The method of claim 11, wherein
the other source comprises a second cryptographic processing unit;
the second cryptographic processing unit communicates with a second user; and the method comprises
using the at least one other key for at least one of encrypting and decrypting information communicated between the cryptographic processing unit and the second cryptographic processing unit.

14. The method of claim 13, comprising
encrypting a communication from the cryptographic processing unit to the second user based on the at least one other key;
determining decrypted second user information based on the at least one other key and encrypted information from the second user; and
providing the decrypted second user information to the computing device.

15. The method of claim 11, comprising
using the first user key for communications with the first user device over a first communication channel; and
using the at least one other key for communications with the at least one other source over a second communication channel.

16. The method of claim 11, wherein
wherein the at least one other key comprises an authentication indicator that indicates when information from the at least one other source is trustworthy; and
the method comprises
determining authenticated information based on the at least one other key and information received from the at least one other source; and
providing the authenticated information to the computing device.

17. The method of claim 11, wherein
the at least one other source is at least one of a data provider or a software provider; and
the computing device uses the at least one of data or software from the other source.

18. The method of claim 11, comprising using the first user key for encrypting a communication to the first user that includes information from the computing device that is based on information received from the at least one other source.

19. The method of claim 11, comprising
determining whether the cryptographic processing unit receives both of the first user key and the at least one other key in a predetermined communication format;
authorizing use of the computing device only if the first user key and the at least one other key are both received in the predetermined communication format; and
preventing use of the computing device if the first user key and the at least one other key are not received in the predetermined communication.

20. The method of claim 19, wherein
the predetermined communication format comprises a single communication from the first user to the cryptographic processing unit, the single communication indicating a desire of the first user to begin a cloud computing session including the computing device.
